(19) United States
(12) Patent Application Publication
(10) Pub. No.: US 2018/0102694 A1
(43) Pub. Date: Apr. 12, 2018

(54) MOTOR APPARATUS AND METHOD OF MANUFACTURING SAME

(71) Applicant: Nidec Corporation, Kyoto (JP)

(72) Inventors: Yoshihisa KITAMURA, Kyoto (JP); Tadayuki KANATANI, Kyoto (JP)

(21) Appl. No.: 15/729,766

(22) Filed: Oct. 11, 2017

(30) Foreign Application Priority Data
Oct. 12, 2016 (JP) 2016-200859

(51) Int. Cl. H02K 11/33; H02K 7/14; H02K 15/10; B29C 45/14

(52) U.S. Cl. CPC H02K 11/33; H02K 7/14; H02K 5/00; B29C 45/14; H02K 15/10

(57) ABSTRACT

A motor apparatus including a motor unit, an external circuit board provided external to the motor unit, a casing that holds the external circuit board, and a first resin portion that coats the external circuit board, in which the motor unit includes a rotating portion that rotates about a central axis that extends vertically, the rotating portion including a magnet, a stationary portion that includes an armature, the stationary portion rotatably supporting the rotating portion, and a second resin portion that coats the armature, in which the casing includes a bracket portion that holds the stationary portion, and in which the first resin portion and the second resin portion are formed in a continuous manner.

### CROSS REFERENCE TO RELATED APPLICATIONS

This application claims the benefit of priority to Japanese Patent Application No. 2016-200859 filed on Oct. 12, 2016. The entire contents of this application are hereby incorporated herein by reference.

### BACKGROUND OF THE INVENTION

### 1. Field of the Invention

The present disclosure relates to a motor apparatus and a method of manufacturing the same.

### 2. Description of the Related Art

Conventionally, in order to achieve waterproofing and insulation, there is known a coating treatment (a so-called potting treatment) in which an armature of a stator and a circuit board inside a motor are coated with a resin material.

For example, a molded motor of Japanese Laid-open Patent Application Publication No. 11-252867 increases insulation property, water resisting property, and humidity resistance by resin molding an outer periphery of a stator with an insulating resin.

Note that U.S. Patent Application Publication No. 2005/0106046 that is another example of a conventional technique related to the present disclosure discloses a fan in which an external circuit board different from a circuit board on which a Hall IC and other members are provided is provided external to the motor.

### SUMMARY OF THE INVENTION

However, as in U.S. Patent Application Publication No. 2005/0106046, in an apparatus in which a circuit board is provided external to a motor, when an armature inside the motor and the circuit board outside the motor are resin molded at different steps, a boundary is created between the resin molds. Accordingly, there may be cases in which water content leaks into and enters the inside through the boundary. Furthermore, there may be cases in which dust enters through the boundary. Accordingly, there is a concern that the dustproof and waterproof function of the apparatus may decrease. Furthermore, when resin molding is performed in different steps, the number of steps increases and the yield cycle time becomes longer; accordingly, the productivity of the apparatus is decreased.

A motor apparatus according to an exemplary embodiment of the present application includes a motor unit, an external circuit board provided external to the motor unit, a casing that holds the external circuit board, and a first resin portion that coats the external circuit board, in which the motor unit includes a rotating portion that rotates about a central axis that extends vertically, the rotating portion including a magnet, a stationary portion that includes an armature, the stationary portion rotatably supporting the rotating portion, and a second resin portion that coats the armature, in which the casing includes a bracket portion that holds the stationary portion, and in which the first resin portion and the second resin portion are formed in a continuous manner.

Furthermore, in order to achieve the above object, a method of manufacturing a motor apparatus according to an aspect of the present disclosure includes a step of attaching a stationary portion of a motor unit to a casing, a step of accommodating an external circuit board in a first accommodation portion provided in the casing, a step of attaching the casing to a metal mold, and a step of injecting a resin material into a space between the casing, the stationary portion, and the metal mold, in which in the step in which the casing is attached to the metal mold, the space is in communication with the first accommodation portion, and in which in the step in which the resin member is injected, the external circuit board and the stationary portion are coated with a resin material in a continuous manner.

According to the present disclosure, a decrease in a dustproof and waterproof function of a motor apparatus that includes an external circuit board 2 can be suppressed or prevented.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view of an air blowing apparatus viewed from above in an axial direction.

FIG. 2 is a perspective view of the air blowing apparatus viewed from below in the axial direction.

FIG. 3 is a cross-sectional view taken along a line extending in a longitudinal direction of the air blowing apparatus.

FIG. 4 is a cross-sectional view taken along a line extending in a short direction of the air blowing apparatus.

FIG. 5 is a side view of a casing illustrating a shape of a third accommodation portion in the longitudinal direction.

FIG. 6 is a flowchart illustrating an exemplary manufacturing method of the air blowing apparatus.

FIG. 7 is a cross-sectional view illustrating a structure in which the casing to which stators and other members have been attached is attached to metal molds.

FIG. 8 is a flowchart illustrating another exemplary manufacturing method of the air blowing apparatus.

FIG. 9A is a bottom view illustrating a first modification of the configuration of the air blowing apparatus.

FIG. 9B is a bottom view illustrating a second modification of the configuration of the air blowing apparatus.

FIG. 9C is a bottom view illustrating a third modification of the configuration of the air blowing apparatus.

### DETAILED DESCRIPTION OF THE PREFERRED EMBODIMENTS

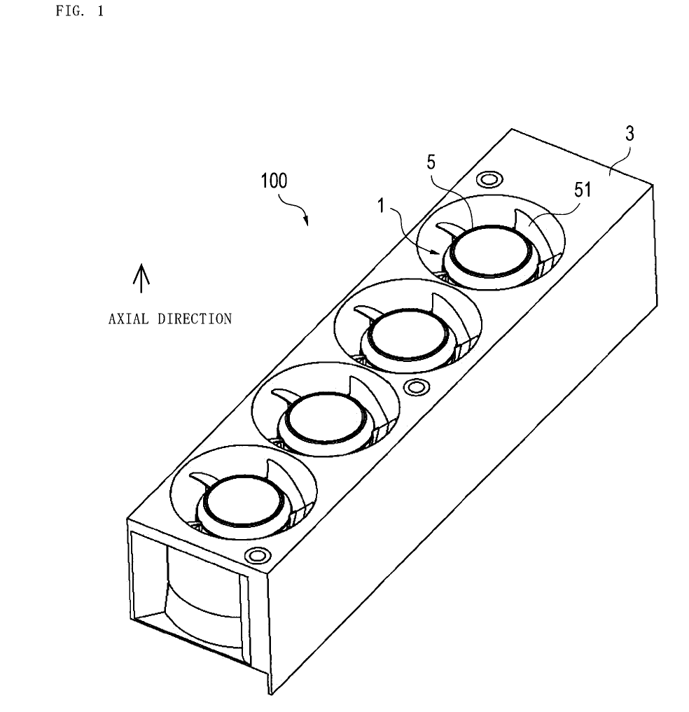

Hereinafter, exemplary embodiments of the present disclosure will be described with reference to the drawings. Note that in the present specification, regarding an apparatus 100 (see FIG. 1 and other figures described later) that includes motor units 1, a direction in which a central axis of a rotor 11 of each motor unit 1 extends while rotating is referred to as an “axial direction”. Moreover, in the axial direction, a direction extending from a bracket portion 31 towards an impeller 5 is referred to as an “upward direction”, and a direction extending from the impeller 5 towards the bracket portion 31 is referred to as a “downward direction”. Furthermore, among the surfaces of each component, a surface oriented towards the upper side in the axial direction is referred to as an “upper surface”, and the surface oriented on the lower side in the axial direction is referred to as an “undersurface”.

Furthermore, in each motor unit 1, a radial direction passing through the central axis of the rotor 11 is referred to as a “radial direction”, and a circumferential direction about the center of the central axis of the rotor 11 is referred to as a “circumferential direction”. Moreover, in the radial direction of each motor unit 1, a direction extending towards the central axis of the rotor 11 is referred to as an “inner direction”, and a direction extending away from the central axis of the rotor 11 is referred to as an “outer direction”. Moreover, among the lateral surfaces of the components of each motor unit 1, a lateral surface oriented towards the inner direction and in the radial direction is referred to as an “inner circumferential surface”, and a lateral surface oriented towards the outer direction and in the radial direction is referred to as an “outer circumferential surface”.

Note that the directions and the naming of the surfaces described above do not illustrate the positional relationships and directions in which the apparatus is actually installed in a piece of equipment.

### 1. Embodiment

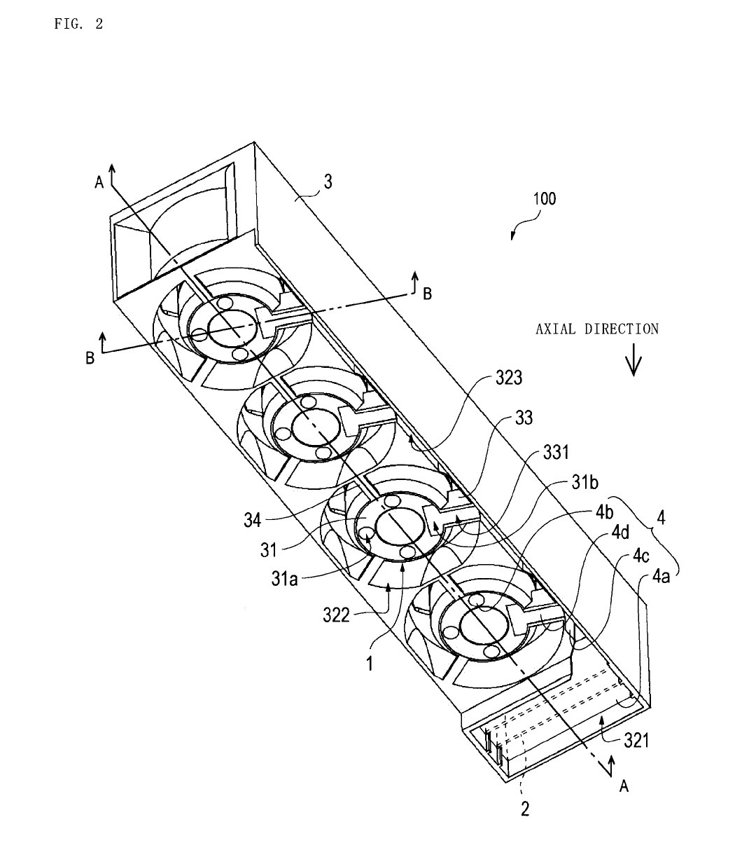

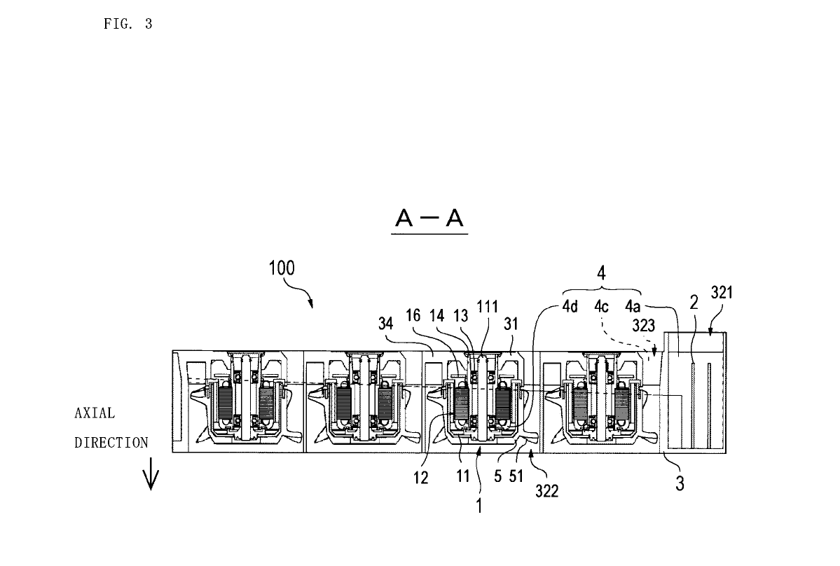

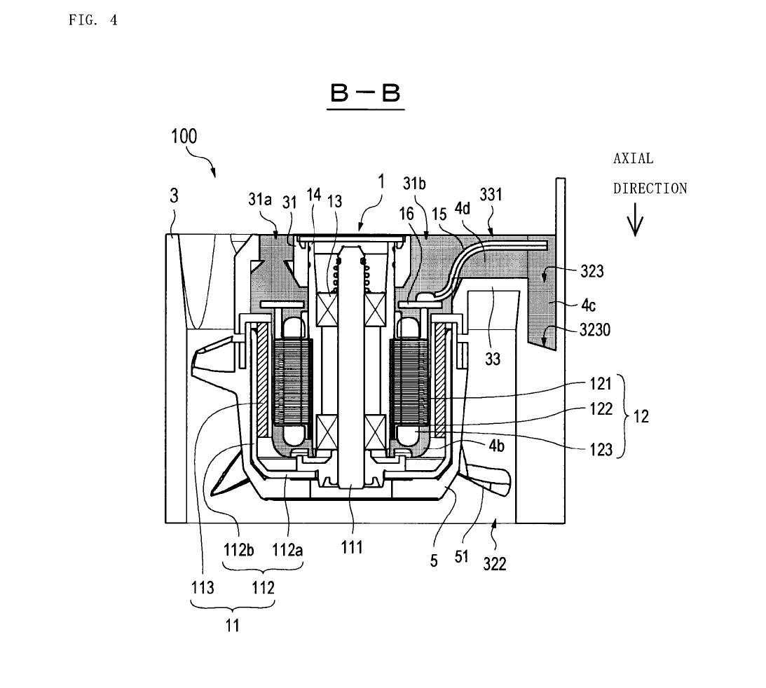

An air blowing apparatus 100 is an example of the motor apparatus of the present disclosure. FIG. 1 is a perspective view of the air blowing apparatus 100 viewed from above in the axial direction. FIG. 2 is a perspective view of the air blowing apparatus 100 viewed from below in the axial direction. FIG. 3 is a cross-sectional view taken along a line extending in the longitudinal direction of the air blowing apparatus 100. FIG. 4 is a cross-sectional view taken along a line extending in the short direction of the air blowing apparatus 100. Note that in the axial direction, the upward direction and the downward direction in FIGS. 3 and 4 and those in FIG. 1 extend in opposite directions. In other words, the upper sides of FIGS. 3 and 4 are the lower side in the axial direction, and the lower sides of FIGS. 3 and 4 are the upper side in the axial direction. Furthermore, FIG. 3 illustrates a cross section structure of the air blowing apparatus 100 taken along line A-A in FIG. 2. FIG. 4 illustrates a cross section structure of the air blowing apparatus 100 taken along line B-B in FIG. 2.

As illustrated in FIGS. 1 to 4, the air blowing apparatus 100 includes four motor units 1, an external circuit board 2, a casing 3, resin members 4, impellers 5 each attached to the corresponding motor unit 1, and lead wires 15.

Each motor unit 1 is a drive that rotationally drives the corresponding impeller 5. Each motor unit 1 is electrically connected to the external circuit board 2 with the corresponding lead wire 15 in between (see FIG. 4).

The external circuit board 2 is, for example, a substrate on which a circuit that controls each motor unit 1 is mounted, and is provided external to the motor units 1.

The casing 3, holds the motor units 1 and the external circuit board 2. Furthermore, as described later, the casing 3 includes the plurality of bracket portions 31 that hold stators 12 and bearing holders 14 of the motor units 1. Note that a specific configuration of the casing 3 will be described later.

The resin members 4 are formed of thermosetting resin such as, for example, silicon resin or epoxy resin. The resin members 4 are each a continuous member including first to fourth resin portions 4a to 4d. The first to fourth resin portions 4a to 4d are provided with the aim to provide a dustproof and waterproof function. Specifically, the air blowing apparatus 100 includes the first resin portion 4a, the third resin portion 4c, and the fourth resin portions 4d. Furthermore, as described later, each motor unit 1 includes the corresponding second resin portion 4b. Note that specific configurations of the first to fourth resin portions 4a to 4d will be described later.

Each impeller 5 is a vane wheel attached to an upper portion of the corresponding motor unit 1, and includes a plurality of vane members 51. The impeller 5 is rotationally driven about a shaft 111 with the motor unit 1, and generates an airflow.

Note that in FIGS. 1 and 2, the number of motor units 1 included in the air blowing apparatus 100 is four; however, not limited to the above exemplification, the number of motor units 1 may be one or may be a plural number other than four. Furthermore, the number of impellers 5 corresponds to the number of motor units 1. Furthermore, while in FIGS. 1 and 2, the plurality of motor units 1 are disposed in a line in the longitudinal direction of the casing 3, the arrangement of the motor units 1 is not limited to the arrangement exemplified in FIGS. 1 and 2. For example, the plurality of motor units 1 may be disposed in n columns and m rows. Note that n and m are both natural numbers that are equivalent to or larger than two. Furthermore, not limited to the exemplification in FIGS. 1 and 2, the direction of arrangement does not have to be the longitudinal direction of the casing 3.

A specific configuration of the motor units 1 will be described next. As illustrated in FIGS. 2 and 4, each motor unit 1 includes the rotor 11, the stator 12, the second resin portion 4b, a bearing 13, the bearing holders 14, and an internal circuit board 16.

The rotor 11 is an example of a rotating portion, and includes the shaft 111, a rotor holder 112, and a magnet 113. The rotor 11 is capable of rotating about the shaft 111. The shaft 111 is a rotating shaft that extends in the up-down direction and in the axial direction. The rotor holder 112 is a member that holds the magnet 113 that opposes the stator 12. Furthermore, the impeller 5 is attached to the rotor holder 112. The rotor holder 112 is capable of rotating together with the shaft 111 and the impeller 5.

The rotor holder 112 includes a plate portion 112a and a cylindrical portion 112b. The plate portion 112a is a disk-shaped member that extends from the shaft 111 in a radially outward direction. The cylindrical portion 112b is a tubular member, and extends from a peripheral edge of the plate portion 112a towards the lower side in the axial direction. The impeller 5 is attached above the plate portion 112a and outside of the cylindrical portion 112b in the radial direction. The magnet 113 is held on an inner surface of the cylindrical portion 112b.

The stator 12 is an example of a stationary portion, and is held by the bracket portion 31 with the bearing holders 14 interposed in between. The stator 12 includes a stator core 121, an insulator 122, and a plurality of coil portions 123. Specifically, the stator 12 includes an armature in which the plurality of coil portions 123 are wound around the stator core 121 with the insulator 122 interposed therebetween, and rotatably supports the rotor 11. The armature opposes the rotor 11, and drives the rotor 11.

The stator core 121 is formed of stacked steel plates in which electromagnetic steel plates are stacked in the axial direction, and is provided external to the bearing holder 14 in the radial direction and internal to the magnet 113 in the radial direction. The insulator 122 is an insulating member including a resin material, for example. The insulator 122 covers the stator core 121, and electrically insulates the stator core 121 and the coil portions 123 from each other. The coil portions 123 are each a winding member in which a conductor line is wound around the insulator 122, and are aligned in the circumferential direction.

The second resin portion 4b coats the armature of the stator 12 and the internal circuit board 16. The second resin portion 4b prevents water from leaking into and dust from entering the armature of the stator 12 and the internal circuit board 16 from the outside of the second resin portion 4b. The second resin portion 4b is continuous with the first resin portion 4a with the third resin portion 4c and the fourth resin portion 4d in between. Due to the above, no boundary is created between the first resin portion 4a coating the external circuit board 2 and the second resin portion 4b coating the armature of the stator 12. Accordingly, leakage of water into and entering of dust into the external circuit board 2 and the armature of the stator 12 through a boundary can be prevented. Accordingly, a decrease in the dustproof and waterproof function of the motor apparatus 100 that includes the external circuit board 2 can be suppressed or prevented.

Moreover, the first resin portion 4a and the second resin portion 4b are provided in a continuous manner. Due to the above, the number of steps in the manufacturing operation of the air blowing apparatus 100 can be reduced compared with a hypothetical case in which the first resin portion 4a and the second resin portion 4b are provided in different steps. Accordingly, yield cycle time of the air blowing apparatus 100 can be shortened and productivity can be improved.

The bearing 13 rotatably supports the shaft 111. For example, a ball bearing, a sleeve bearing, or a slide bearing is used as the bearing 13.

The bearing holder 14 is a metal bearing holding member that holds the bearing 13. As described later, the bearing holder 14 is held by the bracket portion 31 included in the casing 3. Furthermore, the armature of the stator 12 is attached to an outer circumferential surface of the bearing holder 14. In other words, the bearing holder 14 holds the stator 12.

The internal circuit board 16 is electrically connected to the armature of the stator 12, in particular, the internal circuit board 16 is electrically connected to the coil portion 123. Moreover, the internal circuit board 16 is also electrically connected to the external circuit board 2 with the lead wire 15 in between. Note that the rotation frequency of the rotor 11 is detected without any sensors. In other words, the electric current passed through the conductor line or the voltage thereof is read to detect the rotation frequency of the rotor 11. However, a Hall IC may be mounted on the internal circuit board 16, and the rotation frequency of the rotor 11 may be detected with the Hall IC.

A specific configuration of the casing 3 will be described next. As illustrated in FIGS. 1 to 4, the casing 3 includes a first accommodation portion 321, four second accommodation portions 322, a third accommodation portion 323, the bracket portions 31, ribs 33, and two support members 34.

The bracket portion 31 is a member that holds the bearing holder 14 and the stator 12 of the motor unit 1. The motor unit 1 is attached above the bracket portion 31. The bracket portion 31 is provided with three through holes 31a and a single wiring opening 31b. The lead wire 15 connected to the internal circuit board 16 is drawn out external to the motor unit 1 through the wiring opening 31b.

The through holes 31a and the wiring opening 31b are sealed with the second resin portion 4b that coats the armature. Accordingly, water leakage into the armature through the through holes 31a and the wiring opening 31b is prevented.

Furthermore, when the resin member 4 including the second resin portion 4b is formed, the through holes 31a can be used as routes through which a resin material is injected or as discharge routes of air that is pushed out from the inside of the motor unit 1 when the resin material is injected. For example, the resin material can be injected through at least one through hole 31a. In such a case, the air pushed out by the resin material is discharged to the outside of the motor unit 1 through the remaining through holes 31a through which the resin material had not been injected and through the wiring opening 31b. Alternatively, the resin material can be injected through the wiring opening 31b. In such a case, the air that is pushed out by the resin material is discharged to the outside of the motor unit 1 through the through holes 31a.

Note that in FIGS. 1 to 4, the number of through holes 31a is three; however, not limited to the above exemplification, the number of through holes 31a may be one or may be a plural number other than three. In a case in which the number of through holes 31a is one, when forming the resin member 4, the resin material can be injected through either one of the through hole 31a and the wiring opening 31b, and the air can be discharged through the other one of the through hole 31a and the wiring opening 31b. Furthermore, it is more desirable that the number of through holes 31a is a plural number. In such a case, the injection route of the resin material can be increased in accordance with the number of through holes 31a. With the above, the ease of injection of the resin material to form the resin member 4 including the second resin portion 4b is increased. Furthermore, the number of exhaust routes can be increased as well in accordance with the number of through holes 31a. With the above, when the resin material is injected, the ease of discharging the air to the outside of the motor unit 1 through the through holes 31a through which the resin material had not been injected is facilitated.

The first accommodation portion 321 is a recess that is recessed towards the upper side in the axial direction, and the lower end thereof in the axial direction is open. The first accommodation portion 321 accommodates the external circuit board 2. Furthermore, the first resin portion 4a fills the first accommodation portion 321 in which the external circuit board 2 is accommodated. By having the first resin portion 4a fill the first accommodation portion 321, the external circuit board 2 is coated by the first resin portion 4a. Due to the above, leaking of water into and entering of dust into the external circuit board 2 from the outside of the first resin portion 4a can be prevented. Furthermore, by having the first resin portion 4a fill the first accommodation portion 321, entering of water content and dust between the first resin portion 4a and the first accommodation portion 321 is suppressed or prevented. Accordingly, a decrease in the dustproof and waterproof function of the first resin portion 4a can be suppressed or prevented.

Furthermore, the lower end of the first accommodation portion 321 is positioned lower than the lower end of the bracket portion 31 in the axial direction. The above is to prevent the resin material from flowing over from the opening of the first accommodation portion 321 when forming the resin member 4. For example, in a case in which the first resin portion 4a and the second resin portion 4b are formed so as to be continuous with each other while the casing 3 is placed so that the lower portion thereof in the axial direction is on the vertically upper side, the position of the opening of the first accommodation portion 321 is above the position of the position of the lower end of the bracket portions 31 in the vertical direction. In the above state, when the resin material that coats the armature is injected through the through holes 31a of the bracket portion 31, the resin material also flows into the first accommodation portion 321 continuously connected to the inside of the motor unit 1. Note that the liquid surface of the resin material that has flowed into the first accommodation portion 321 does not flow higher than the lower end of the bracket portion 31. Accordingly, the resin material can be prevented from flowing over from the opening of the first accommodation portion 321 when the resin member 4 is formed.

Each second accommodation portion 322 is a hole that penetrates the casing 3 in the axial direction from the upper end to the lower end. The motor unit 1 is accommodated in the second accommodation portions 322. Specifically, the rib 33 that extend in the radial direction and the bracket portion 31 supported by the support member 34 are provided in the lower end of the second accommodation portion 322. In other words, the position of the bracket portion 31 with respect to the second accommodation portion 322 in the axial direction is, similar to the opening of the first accommodation portion 321, on the lower side of the casing 3. Due to the above, the first resin portion 4a filling the first accommodation portion 321 can be formed continuous with the second resin portion 4b through a shorter route.

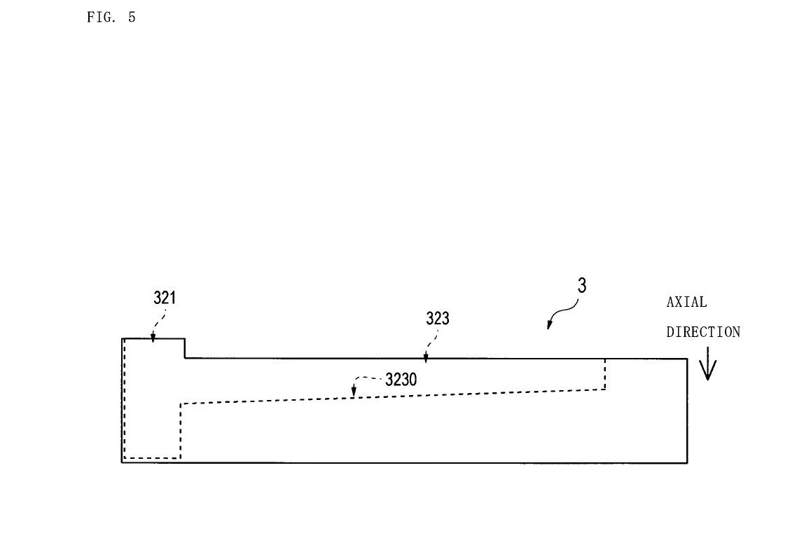

The third accommodation portion 323 will be described next. FIG. 5 is a side view of the casing 3 illustrating a shape of the third accommodation portion 323 in the longitudinal direction. Note that in the axial direction, the upward direction and the downward direction in FIG. 5 and those in FIG. 1 extend in opposite directions. In other words, the upper side of FIG. 5 is the lower side in the axial direction, and the lower side of FIG. 5 is the upper side in the axial direction. Furthermore, the broken line in FIG. 5 indicates the shapes of the first accommodation portion 321 and the third accommodation portion 323.

The third accommodation portion 323 is a groove portion that is recessed towards the upper side in the axial direction, and extends in the direction in which the four motor units 1 are arranged. Accordingly, the shape of each third accommodation portion 323 accommodating the lead wire 15 of the corresponding motor unit 1 can be simplified so that the shape does not become complex, such as a bent and extended shape. Accordingly, when forming the third resin portion 4c, the resin material can be filled easily into the third accommodation portion 323 in a more uniform manner.

The lead wires 15 that extend from the motor units 1 towards the external circuit board 2 inside the first accommodation portion 321 are accommodated inside the third accommodation portion 323. Furthermore, the third resin portion 4c fill the third accommodation portion 323 in which the lead wires 15 are accommodated. Due to the above, the lead wires 15 inside the third accommodation portion 323 can be fixed with the third resin portion.

Furthermore, the third accommodation portion 323 is in communication with the first accommodation portion 321, and is in communication with the space inside the motor units 1 with fourth accommodation portions 331 described later in between. Accordingly, the first resin portion 4a and the second resin portions 4b are continuous with the third resin portion 4c in between. In other words, the first resin portion 4a coating the external circuit board 2, the second resin portions 4b that coat the armatures of the stators 21, the third resin portion 4c that coats the lead wires 15 are formed in a continuous manner. With the above, no boundaries will be created between the first resin portion 4a and the second resin portions 4b, and the third resin portion 4c, such that leaking of water and entering of dust through a boundary can be prevented. Accordingly, a decrease in the dustproof and waterproof function of the air blowing apparatus 100 can be suppressed or prevented.

Furthermore, the lower end of the third accommodation portion 323 in the axial direction is open. In other words, the opening of the third accommodation portion 323 is on the lower side in the axial direction, as same as the openings of the bracket portions 31 and the first accommodation portion 321 are on the lower side in the axial direction with respect to the second accommodation portions 322. Accordingly, the third resin portion 4c can be in contact with the first resin portion 4a and the second resin portions 4b through a shorter route.

Furthermore, as illustrated in FIG. 5, the depth of the third accommodation portion 323 in the axial direction becomes larger as the third accommodation portion 323 becomes closer to the first accommodation portion 321. With the above, in a state in which the casing 3 is mounted so that the lower side thereof in the axial direction is on the vertically upper side, the depth of a bottom surface 3230 of the third accommodation portion 323 in the vertical direction becomes larger as the bottom surface 3230 becomes closer to the first accommodation portion 321 and becomes smaller as the bottom surface 3230 becomes farther away from the first accommodation portion 321. Due to the above, the resin material flows more easily from the third accommodation portion 323 to the first accommodation portion 321 when forming the resin member 4, for example. Accordingly, the third resin portion 4c can be formed continuously with the first resin portion 4a more easily.

Furthermore, the depth of the third accommodation portion 323 in the axial direction becomes smaller as the third accommodation portion 323 becomes closer to the second accommodation portions 322 (see FIG. 4). In a state in which the casing 3 is mounted so that the lower side in the axial direction is on the vertically upper side, the depth of the bottom surface 3230 of the third accommodation portion 323 in the vertical direction becomes smaller as the bottom surface 3230 becomes closer to the second accommodation portions 322 in which the motor units 1 are accommodated, and becomes larger as the bottom surface 3230 becomes father away from the second accommodation portions 322. Due to the above, in the third accommodation portion 323, the resin material flows more easily from the position closer to the second accommodation portions 322 to the position farther away from the second accommodation portions 322 when forming the third resin portion 4c, for example. Accordingly, pouring the resin material into the third accommodation portion 323 in a relatively uniform manner, the third resin portion 4c can more easily fill the third accommodation portion 323 without creating any gaps.

Note that the shape of the bottom surface 3230 of the third accommodation portion 323 is not limited to any shape in particular, the bottom surface 3230 may be a flat surface, a curved surface, or a stepped surface. In particular, the bottom surface 3230 may be a surface that is curved or stepped in the longitudinal direction or the short direction of the casing 3.

Referring again to FIGS. 1 to 4, a description of the ribs 33 and the two support members 34 will be given next. The ribs 33 and the two support members 34 support the bracket portions 31 in the second accommodation portions 322. One ends of the ribs 33 and the two support members 34 are connected to the bracket portions 31. Furthermore, the other ends of the ribs 33 and the two support members 34 are connected to the inner circumferential surfaces of the second accommodation portions 322 or the peripheral edges of the lower ends of the second accommodation portions 322.

The ribs 33 include the fourth accommodation portions 331. The fourth accommodation portions 331 are in communication with the wiring openings 31b of the bracket portions 31 the third accommodation portion 323. Furthermore, the lead wires 15 that are drawn out from the wiring openings 31B of the motor units 1 to the third accommodation portion 323 are accommodated in the fourth accommodation portions 331, and the fourth resin portions 4d fill the fourth accommodation portions 331. Due to the above, the lead wires 15 inside the fourth accommodation portions 331 are fixed by the fourth resin portions 4d. Furthermore, the insides of the motor units 1 are in communication with the third accommodation portion 323 through the wiring openings 31b and the fourth accommodation portions 331. Accordingly, the second resin portions 4b and the third resin portion 4c are continuous with each other through the fourth accommodation portions 331 of the ribs 33.

Furthermore, the ribs 33 support the bracket portions 31 at positions that are closer to the third accommodation portion 323 than the two support members 34. Due to the above, the second resin portions 4b inside the motor units 1 can be formed continuous with the third resin portion 4c through a shorter route.

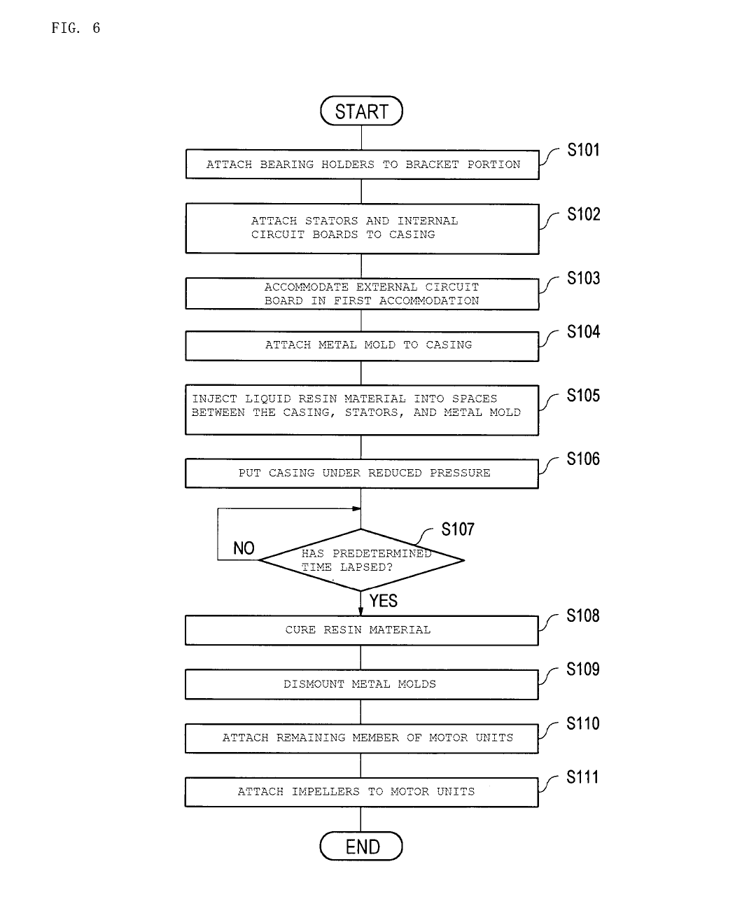

A method of manufacturing the air blowing apparatus 100 will be described next. FIG. 6 is a flowchart illustrating an exemplary manufacturing method of the air blowing apparatus 100. Note that the process in FIG. 6 is performed while the lower end of the casing 3 is on the vertically upper side. In other words, the process in FIG. 6 is performed while the lower side of the air blowing apparatus 100 in the axial direction is on the vertically upper side.

First, the bearing holders 14 are attached to the bracket portions 31 of the casing 3 (step S101). The stators 12 and the internal circuit boards 16 are attached to the casing 3 (step S102). Specifically, the stators 12 including the armatures provided on the stator cores 121 provided with coil portions 123 with the insulator 122 interposed in between are attached to the bearing holders 14 on the bracket portions 31 of the casing 3. Furthermore, internal circuit boards 16 to which the lead wires 15 are connected are attached to the stators 12.

The external circuit board 2 is accommodated in the first accommodation portion 321 provided in the casing 3 (step S103). In so doing, the lead wires 15 connected to the internal circuit boards 16 are connected to the external circuit board 2 as well.

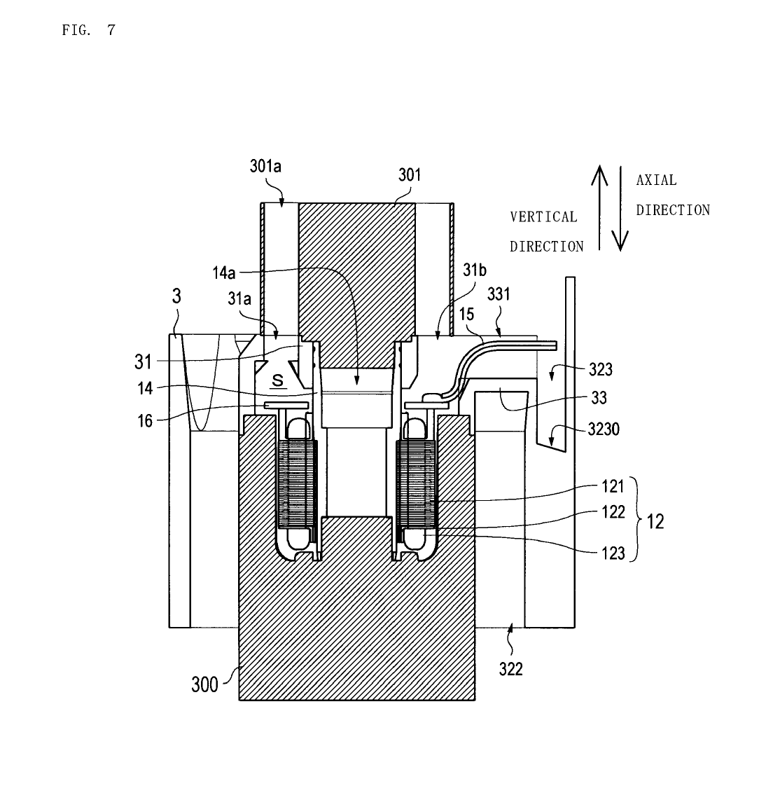

Next, the casing 3 is attached to metal molds 300 and 301 (step S104). FIG. 7 is a cross-sectional view illustrating a structure in which the casing 3 to which the stators 12 and other members have been attached is attached to the metal molds 300 and 301. Note that FIG. 7 illustrates a cross section structure taken along a line extending in the short direction of the casing 3. As illustrated in FIG. 7, the metal mold 300 is inserted vertically downwards into the second accommodation portions 322. The metal mold 300 is attached to the upper surface of the bracket portions 31. In so doing, the armatures of the stators 12 are accommodated inside the metal mold 300. Furthermore, the hole protecting metal mold 301 is attached to the undersurfaces of the bracket portions 31 on the vertically upper side. In so doing, the hole protecting metal mold 301 is attached so that injection holes 301a of the resin material are in communication with the through holes 31a of the bracket portions 31. Upper ends of hole portions 14a of the bearing holders 14 in the axial direction are closed with the metal mold 300, and lower ends of the hole portions 14a are closed by the hole protecting metal mold 301. In so doing, spaces S inside the motor units 1 between the casing 3, the stators 12, and the metal mold 300 are in communication with the first accommodation portion 321 in a continuous manner with the wiring openings 31b, the fourth accommodation portions 331 of the ribs 33, and the third accommodation portion 323 in between.

A liquid resin material is injected from the injection holes 301a through the through holes 31a into the spaces S between the casing 3, the stators 12, and the metal mold 300 (step S105). In so doing, the spaces S are filled with the injected resin material. Note that there is nothing that blocks the flow of the resin material inside the route between the spaces S and the first accommodation portion 321. Accordingly, the injected resin material flows into the first accommodation portion 321 from the spaces S through the wiring openings 31b, the fourth accommodation portions 331, and the third accommodation portion 323, and is filled into the spaces S, the first accommodation portion 321, the third accommodation portion 323, and the fourth accommodation portions 331. Accordingly, the external circuit board 2, the stators 12, the lead wires 15, and the internal circuit boards 16 are coated with the resin material in a continuous manner.

Subsequently, the casing 3 into which the resin material has been injected is put under reduced pressure (step S106). For example, the casing 3 into which the resin material has been injected is put inside a closed space inside a vacuum chamber, and the closed space inside the closed vacuum chamber is decompressed to a predetermined degree of vacuum with a vacuum pump. After lapse of a predetermined time from when the predetermined degree of vacuum had been reached (YES in step S107), the pressure of the closed space is returned to atmospheric pressure, and the casing 3 into which the resin material has been injected is taken out.

A predetermined heat treatment and other treatments are performed on the casing 3 to cure the resin material (S108). With the above treatment, resin members 4 are formed in the spaces S, the first accommodation portion 321, the third accommodation portion 323, and the fourth accommodation portions 331 in a continuous manner.

The metal molds 300 and 301 are dismounted from the casing 3 (step S109). The remaining members of the motor units 1 such as the rotors 11 including the bearings 13 and the shafts 111 are attached (step S110). The impellers 5 are attached to the motor units 1 (step S111). Accordingly, the process in FIG. 6 is completed.

Note that in the manufacturing method described above, the resin injection process is performed in the spaces S in step S105; however, the injection of the resin material is not limited to the above exemplification. The injection of the resin material may be performed in at least either one of the first accommodation portion 321, the third accommodation portion 323, and the fourth accommodation portions 331 at the same time with the injection into the spaces S.

According to the manufacturing method described above, the external circuit board 2 and the stators 12 of the motor units 1 are coated with the resin material (that is, the resin material 4) in a continuous manner. Due to the above, no boundary is created between the first resin portion 4a coating the external circuit board 2 and the second resin portions 4b coating the stators 12. Accordingly, leakage of water into and entering of dust into the external circuit board 2 and the stators 12 through a boundary can be prevented. Accordingly, a decrease in the dustproof and waterproof function of the air blowing apparatus 100 including the external circuit board 2 and be suppressed or prevented.

Moreover, since no boundary is created in each resin member 4, the process in FIG. 6 can reduce the number of steps compared with a case in which the step of coating the external circuit board 2 with the resin material and the step of coating the stators 12 with the resin material are provided in different steps. Accordingly, yield cycle time of the air blowing apparatus 100 is shortened and productivity can be improved.

Furthermore, according to the manufacturing method in FIG. 6, the air in the spaces S between the injected resin material, and the casing 3, the stators 12, and the metal mold 300 can be removed (that is, degassed) by putting the casing 3 into which the resin material has been injected in step S106 under reduced pressure. Accordingly, the resin material can be filled into the spaces S between the casing 3, the stators 12, and the metal mold 300 without creating any gaps. Furthermore, the bubbles included in the injected resin material can be removed as well. Accordingly, the dustproof and waterproof function of the resin members 4 coating the external circuit board 2 and the stators 12 in a continuous manner can be improved further.

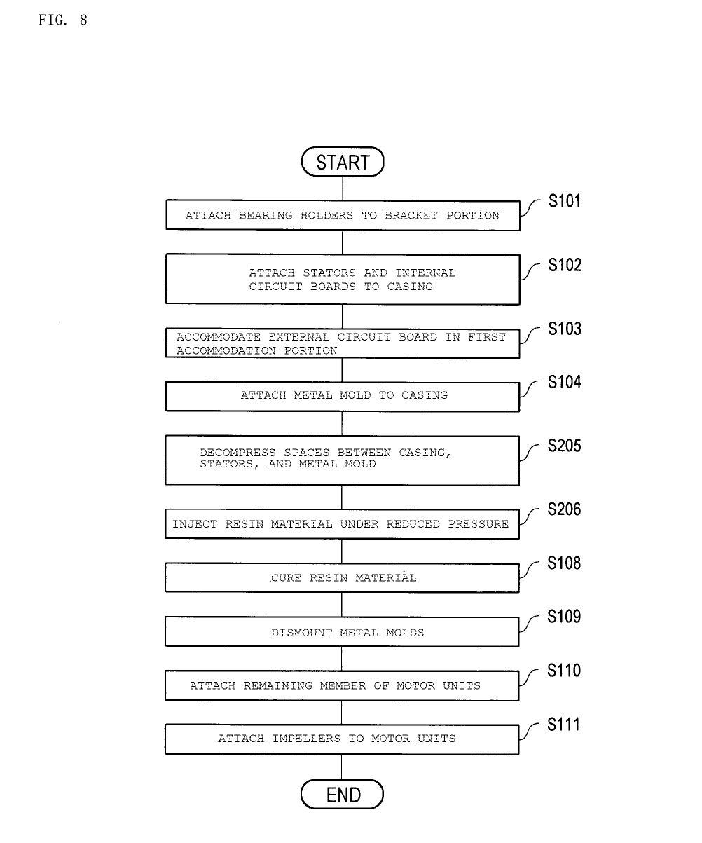

In the method of manufacturing the air blowing apparatus 100, the resin material may be injected into the spaces S under a decompressed environment. FIG. 8 is a flowchart illustrating an exemplary manufacturing method of the air blowing apparatus 100. Note that the process in FIG. 8 is also performed while the lower end of the casing 3 is on the vertically upper side. In other words, the process in FIG. 8 is performed while the lower side of the air blowing apparatus 100 in the axial direction is on the vertically upper side. Furthermore, since the processes in steps S101 to S104 and S108 to S111 in FIG. 8 are the same as those in FIG. 6, description thereof is omitted.

After the metal molds 300 and 301 are attached to the casing 3 in step S104, a liquid resin material is injected into the spaces S while the spaces S are in a decompressed state. Specifically, the ambient environment of the casing 3 is decompressed to a predetermined degree of vacuum with a method such as, for example, performing decompression inside a vacuum chamber, and the spaces S is decompressed as well (step S205). Subsequently, the liquid resin material is injected inside the decompressed spaces S (step S206). After completion of the injection, the pressure of the ambient environment of the casing 3 is returned to atmospheric pressure, and the casing 3 into which the resin material has been injected is taken out. Note that the pressures of the ambient environment of the casing 3 and the spaces S may be returned to atmospheric pressure after a predetermined time period has passed since the completion of the injection. Subsequently, the processes of S108 to S111 are performed.

According to the first modification of the manufacturing method illustrated in FIG. 8, by having the resin material be injected under reduced pressure, the injected resin material is more easily filled into every corner of the spaces S between the casing 3, the stators 12, and the metal mold 300. Similarly, the injected resin material can be filled easily into every corner of the first accommodation portion 321, the third accommodation portion 323, and the fourth accommodation portions 331. Furthermore, bubble becoming mixed into the injected resin material can be suppressed or prevented as well. Accordingly, the dustproof and waterproof function of the resin members 4 coating the external circuit board 2, the stators 12, and other members in a continuous manner can be improved further.

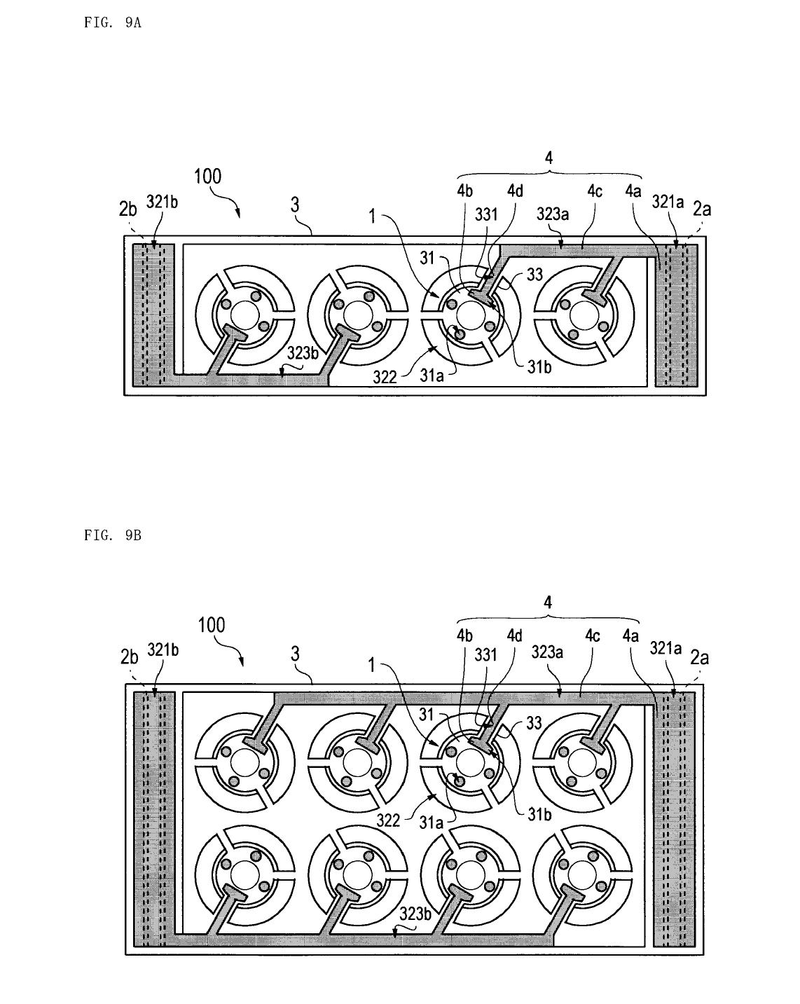

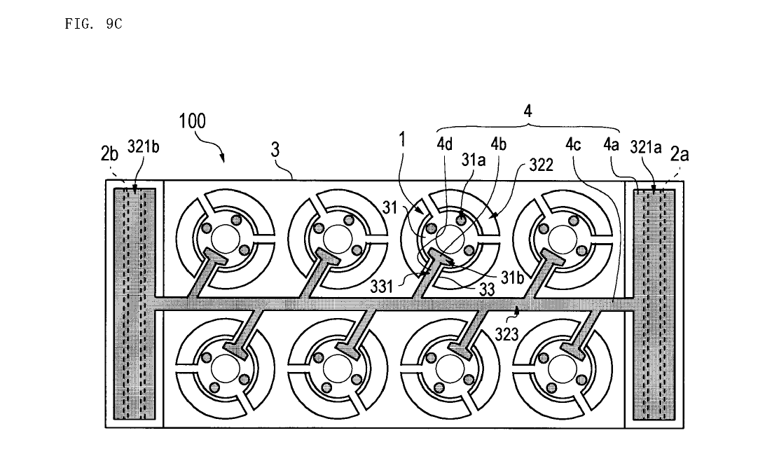

In FIGS. 2 to 4, the numbers of the first accommodation portion 321 and the third accommodation portion 323 included in the casing 3 are each a singular number; however, not limited to the exemplification in FIGS. 2 to 4, the numbers may be plural numbers. FIGS. 9A to 9C are modifications of the configuration of the air blowing apparatus 100. FIG. 9A is a bottom view illustrating a first modification of the configuration of the air blowing apparatus. FIG. 9B is a bottom view illustrating a second modification of the configuration of the air blowing apparatus. FIG. 9C is a bottom view illustrating a third modification of the configuration of the air blowing apparatus. Note that in FIGS. 9A to 9C, an external circuit board 2a accommodated in a first accommodation portion 321a on one side is electrically connected to an external circuit board 2b accommodated in a first accommodation portion 321b on the other side with wiring in a route (not shown) provided in the casing 3 in between.

Referring to FIG. 9A, the casing 3 includes two first accommodation portions 321a and 321b and two third accommodation portions 323a and 323b. Among the four motor units 1 aligned in one direction, two motor units 1 are connected to the external circuit board 2a accommodated in the first accommodation portion 321a on one side with the lead wires 15 accommodated in the third accommodation portion 323a on one side. Furthermore, among the four motor units 1 aligned in one direction, two motor units 1 are connected to the external circuit board 2b accommodated in the first accommodation portion 321b on the other side with the lead wires 15 accommodated in the third accommodation portion 323b on the other side. Note that the allocation of the motor units 1 connected to the external circuit board 2a and the motor units 1 connected to the external circuit board 2b is not limited to the exemplification in FIG. 9A. For example, among the four motor units 1 arranged in one direction, three motor units 1 may be connected to the external circuit board 2a, and the remaining one may be connected to the external circuit board 2b.

Furthermore, in FIG. 9A, all the motor units 1 are arranged in one direction and the third accommodation portions 323 extend in the direction in which the motor units 1 are arranged. However, the plurality of motor units 1 may be arranged such that some of the motor units 1 are arranged in one direction on the casing 3, and the remaining motor units 1 are not arranged in the one direction. In such a case, it is only sufficient that the third accommodation portion 323 that accommodates the lead wires 15 of some of the motor units 1 may be arranged so as to extend in the direction in which some of the motor units 1 are arranged. In other words, in a case in which, among the plurality of motor units 1, at least some of the motor units 1 are arranged in one direction on the casing 3, it is only sufficient that the third accommodation portion 323 accommodating the lead wires 15 of the at least some of the motor units 1 extends in the direction in which the at least some of the motor units 1 are arranged. With the above, the shape of each third accommodation portion 323 accommodating the lead wire 15 of the at least some of the motor units 1 can be configured so that the shape does not become complex, such as a bent and extended shape. Accordingly, when forming the third resin portion 4c, the resin material can be filled into the third accommodation portion 323 in a more uniform manner.

Furthermore, in a case in which a plurality of motor units 1 (and the second accommodation portions 322) are arranged as a two-dimensional array, the first accommodation portion 321, the external circuit board 2, and the third accommodation portion 323 may be provided in each column or each row. In FIG. 9B, eight motor units 1 (and second accommodation portions 322) are arranged in four columns and two rows. Note that hereinafter, “column” refers to the arrangement in the longitudinal direction of the casing 3, and the “row” refers to the arrangement in the short direction of the casing 3. Among the motor units 1 aligned in two columns, four motor units 1 aligned in one of the columns are connected to the external circuit board 2a accommodated in the first accommodation portion 321a on one side with the lead wires 15 accommodated in the third accommodation portion 323a on one side. Furthermore, the four motor units 1 aligned in the other column are connected to the external circuit board 2b accommodated in the first accommodation portion 321b on the other side with the lead wires 15 accommodated in the third accommodation portion 323b on the other side.

Furthermore, in a case in which a plurality of motor units 1 (and the second accommodation portions 322) are arranged as a two-dimensional array, a single first accommodation portion 321 may be provided to the motor units 1 included in two adjacent columns or to the motor units 1 included in two adjacent rows. In FIG. 9C, the casing 3 includes two first accommodation portions 321a and 321b and a single third accommodation portion 323. Among the motor units 1 aligned in four rows and two columns, four motor units 1 aligned in one of the columns are connected to the external circuit board 2a accommodated in the first accommodation portion 321a on one side with the lead wires 15 accommodated in the third accommodation portion 323. Furthermore, the four motor units 1 aligned in the other column are connected to the external circuit board 2b accommodated in the first accommodation portion 321b on the other side with the lead wires 15 accommodated in the third accommodation portion 323.

By having plural numbers of first accommodation portions 321 and plural numbers of third accommodation portions 323, the degree of freedom in design, such as the dispositions of the motor units 1 and the external circuit board 2, and the wiring patterns between the motor units 1 and the external circuit board 2 is increased.

Embodiments of the present disclosure have been described above. Note that the scope of the present disclosure is not limited to the embodiments described above. The present disclosure may be implemented with various modifications added thereto within the scope of the disclosure. Furthermore, the above embodiments may be combined as appropriate in any manner.

For example, in the embodiments described above, the motor units 1 include internal circuit boards 16; however, the application range of the present disclosure is not limited to the exemplification above. The present disclosure can be applied to an apparatus 100 in which the internal circuit board 16 is not provided in at least one of the motor units 1.

Furthermore, while in the embodiments described above, the present disclosure is applied to the apparatus 100 including the outer rotor motor units 1, the application range of the present disclosure is not limited to the application range of the above exemplifications. The present disclosure can be applied to apparatuses including an inner rotor motor unit as well.

The present disclosure can be used in apparatuses including a motor unit and a circuit board external to the motor unit, for example.

Features of the above-described preferred embodiments and the modifications thereof may be combined appropriately as long as no conflict arises.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A motor apparatus comprising:
a motor unit;
an external circuit board provided external to the motor unit;
a casing that holds the external circuit board; and
a first resin portion that coats the external circuit board,
wherein the motor unit includes
a rotating portion that rotates about a central axis that extends vertically, the rotating portion including a magnet,
a stationary portion that includes an armature, the stationary portion rotatably supporting the rotating portion, and
a second resin portion that coats the armature,
wherein the casing includes a bracket portion that holds the stationary portion, and
wherein the first resin portion and the second resin portion are formed in a continuous manner.

2. The motor apparatus according to claim 1,
wherein the bracket portion includes a through hole that penetrates the bracket portion in an axial direction, and
wherein the through hole is sealed with the first resin portion or the second resin portion.

3. The motor apparatus according to claim 2,
wherein the through hole is provided in plural numbers.

4. The motor apparatus according to claim 1,
wherein the casing further includes a first accommodation portion that accommodates the external circuit board, and
wherein the first resin portion fills the first accommodation portion.

5. The motor apparatus according to claim 4,
wherein the casing further includes a second accommodation portion in which the motor unit is accommodated, and
wherein a lower end of the first accommodation portion in an axial direction is open, and the bracket portion is provided in a lower end of the second accommodation portion in the axial direction.

6. The motor apparatus according to claim 5,
wherein a position of the lower end of the first accommodation portion is lower than a position of a lower end of the bracket portion in the axial direction.

7. The motor apparatus according to claim 5, further comprising:
wiring that electrically connects the stationary portion and the external circuit board to each other; and
a third resin portion that coats the wiring,
wherein the casing includes a third accommodation portion that accommodates the wiring, and
wherein the first resin portion and the second resin portion are formed in a continuous manner with the third resin portion interposed therebetween.

8. The motor apparatus according to claim 7,
wherein a lower end of the third accommodation portion in an axial direction is open.

9. The motor apparatus according to claim 7,
wherein the third resin portion fills the third accommodation portion.

10. The motor apparatus according to claim 7,
wherein the motor unit is provided in plural numbers, and at least some of the motor units are arranged in one direction on the casing, and
wherein the third accommodation portion that accommodates the wiring of the at least some of the motor units extend in a direction in which the at least some of the motor units are arranged.

11. The motor apparatus according to claim 7,
wherein a depth of the third accommodation portion in an axial direction becomes larger as the third accommodation portion becomes closer to the first accommodation portion.

12. The motor apparatus according to claim 7,
wherein a depth of the third accommodation portion in an axial direction becomes smaller as the third accommodation portion becomes closer to the second accommodation portion.

13. The motor apparatus according to claim 7,
wherein a bottom surface of the third accommodation portion is a curved surface or a stepped surface.

14. The motor apparatus according to claim 7,
wherein a wiring opening through which the wiring of the motor unit is drawn out is provided in an undersurface of the bracket portion in an axial direction,
wherein the casing further includes a rib, the rib including a fourth accommodation portion in which the wiring is accommodated, and
wherein an inside of the motor unit is in communication with the third accommodation portion through the wiring opening and the fourth accommodation portion.

15. The motor apparatus according to claim 7,
wherein the external circuit board, the first accommodation portion included in the casing, and the third accommodation portion are provided in plural numbers.

16. A method of manufacturing a motor apparatus according to claim 1, the method comprising:
a step of attaching a stationary portion of a motor unit to a casing;
a step of accommodating an external circuit board in a first accommodation portion provided in the casing;
a step of attaching the casing to a metal mold; and
a step of injecting a resin material into a space between the casing, the stationary portion, and the metal mold,
wherein in the step in which the casing is attached to the metal mold, the space is in communication with the first accommodation portion, and
wherein in the step in which the resin member is injected, the external circuit board and the stationary portion are coated with a resin material in a continuous manner.

17. The method of manufacturing a motor apparatus according to claim 16, further comprising:
a step of putting the casing, in which the resin material has been injected, under a reduced pressure.

18. The method of manufacturing a motor apparatus according to claim 16,
wherein the step in which the resin material is injected includes a step of decompressing the space between the casing, the stationary portion, and metal mold, and
wherein the resin material is injected into the space that has been decompressed.
